(19) United States
(12) Patent Application Publication
(10) Pub. No.: US 2025/0111292 A1
(43) Pub. Date: Apr. 3, 2025

(54) INFORMATION PROVIDING SYSTEM, INFORMATION PROVIDING METHOD, AND NON-TRANSITORY COMPUTER-READABLE MEDIUM STORING PROGRAM

(71) Applicant: RAKUTEN GROUP, INC., Tokyo (JP)

(72) Inventors: Asami EBISAWA, Tokyo (JP); Masahiro Kuwahara, Tokyo (JP)

(73) Assignee: RAKUTEN GROUP, INC., Tokyo (JP)

(21) Appl. No.: 18/677,082

(22) Filed: May 29, 2024

(30) Foreign Application Priority Data
May 31, 2023 (JP) 2023-089671

(51) Int. Cl. G06Q 10/02; G06Q 10/04

(52) U.S. Cl. CPC G06Q 10/02; G06Q 10/04

(57) ABSTRACT

An information providing system includes one or more processors and a memory that stores one or more programs executed by the one or more processors. The one or more programs cause the one or more processors to execute obtaining weather data for one round day on a golf course, the golf course including holes, obtaining cup positions set respectively in the holes for the one round day, estimating a round time for the one round day from the weather data and the cup positions, and providing the estimated round time.

### CROSS-REFERENCE TO RELATED APPLICATIONS

This application is based upon and claims the benefit of priority from prior Japanese Patent Application No. 2023-089671, filed on May 31, 2023, the entire contents of which are incorporated herein by reference.

### BACKGROUND

### 1. Field

The following description relates to an information providing system, an information providing method, and a non-transitory computer-readable medium storing a program.

### 2. Description of Related Art

Generally, the cup position on each hole of a golf course is changed daily to prevent localized damage to the grass on the green. Japanese Laid-Open Patent Publication No. 2014-117570 discloses an example of an information providing system that estimates the round time for playing all the holes on a golf course from the cup positions. With the estimated round time, the golf course manager can easily adjust the cup positions.

In this information providing system, the round time is estimated from the round order, the number of players per round, and the cup positions.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An information providing system according to an aspect of the present disclosure includes one or more processors and a memory that stores one or more programs executed by the one or more processors. The one or more programs cause the one or more processors to execute obtaining weather data for one round day on a golf course, the golf course including holes, obtaining cup positions set respectively in the holes for the one round day, estimating a round time for the one round day from the weather data and the cup positions, and providing the estimated round time.

An information providing method according to an aspect of the present disclosure includes obtaining, by one or more computers, weather data for one round day on a golf course, the golf course including holes, obtaining, by the one or more computers, cup positions set respectively in the holes for the one round day, estimating, by the one or more computers, a round time for the one round day from the weather data and the cup positions, and providing, by the one or more computers, the estimated round time.

A non-transitory computer-readable medium according to an aspect of the present disclosure stores a program for causing one or more computers to execute obtaining weather data for one round day on a golf course, the golf course including holes, obtaining cup positions set respectively in the holes for the one round day, estimating a round time for the one round day from the weather data and the cup positions, and providing the estimated round time.

Other features and aspects will be apparent from the following detailed description, the drawings, and the claims.

### BRIEF DESCRIPTION OF THE DRAWINGS

FIG. 1 is a diagram illustrating an overall configuration of an information providing system according to an embodiment.

FIG. 2 is a diagram illustrating an electrical configuration of the terminal device in the embodiment.

FIG. 3 is a diagram illustrating an electrical configuration of the information providing device in the embodiment.

FIG. 4 is a table showing the round history in the embodiment.

FIG. 5 is a diagram illustrating a green area in the embodiment.

FIG. 6 is a flowchart illustrating a setting control process in the embodiment.

FIG. 7 is a flowchart illustrating a play history control process in the embodiment.

FIG. 8 is a flowchart illustrating a cup position determination process in the embodiment.

FIG. 9 is a flowchart illustrating the cup position determination process in the embodiment.

FIG. 10 is a diagram illustrating the display screen on the terminal display in the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

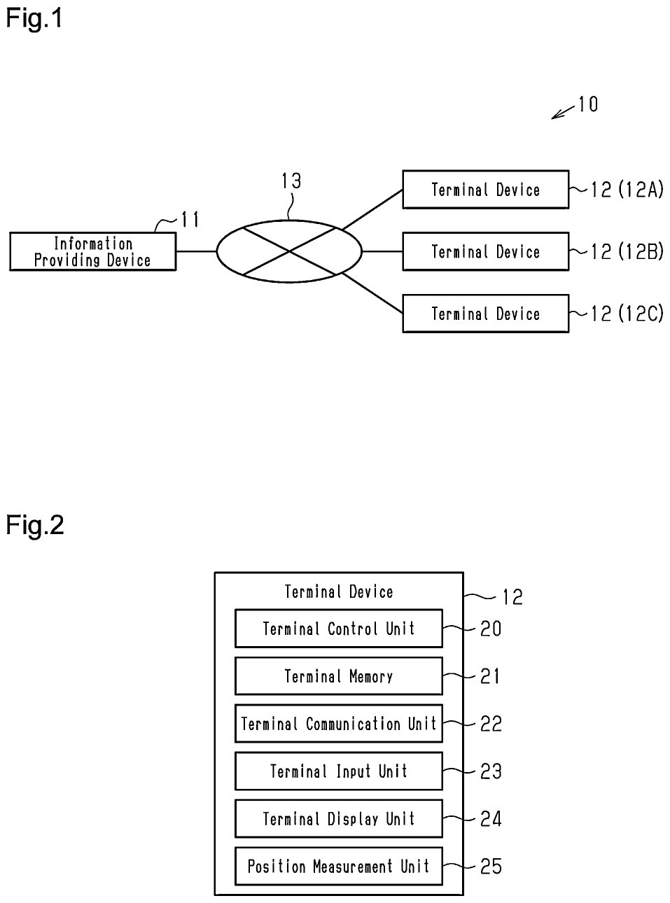

An information providing device 11, an information providing system 10, an information providing method, and a non-transitory computer-readable medium storing a program according to an embodiment will now be described with reference to FIGS. 1 to 10.

### Configuration of Information Providing System 10

As shown in FIG. 1, the information providing system 10 provides various types of information, particularly information related to cup positions on a golf course.

In this embodiment, the golf course includes multiple holes. Each hole has a green. Each green includes a cup. The position where the cup is located on the green is referred to as a cup position. Golf is a sport in which players compete by counting the number of strokes taken to get the ball from the tee shot on the teeing ground into the cup on the green at each hole. Thus, a cup position is a factor that affects not only the difficulty level of a round of golf, but also affects the overall performance results.

In golf, the conditions of a round change not only based on the cup position but also the weather on a round day. For example, when the weather on the round day is rainy or snowy, the course conditions change compared to when the weather is sunny or cloudy, significantly affecting the ball trajectory. Further, if the golf club becomes wet, the grip condition of the golf club changes. Furthermore, when the weather on the round day is very windy, the ball trajectory is significantly affected compared to when the weather is not windy. Thus, weather is a factor that affects not only the difficulty level of a round of golf, but also affects the overall performance results.

The information providing system 10 includes an information providing device 11. The information providing device 11 is, for example, a server for providing various types of information. The information providing system 10 may include one or more terminal devices 12. For example, multiple terminal devices 12 may include a first terminal device 12A, a second terminal device 12B, and a third terminal device 12C.

The first terminal device 12A may be a management device used by managers who manage the golf course. The second terminal device 12B may be installed on a golf course cart. The third terminal device 12C may be used by workers who install the cups. At least one of the terminal devices 12 may be used by players (golfers) playing golf on the golf course.

The information providing device 11 and one or more terminal devices 12 are connected in a manner that allows communication via a network 13. At least some of the information providing device 11 and the terminal devices 12 may be connected in a manner that allows direct communication without using an external network, such as the Internet. Hereinafter, communication between the devices via the network 13 will not be described.

### Configuration of Terminal Device 12

The terminal device 12 shown in FIG. 2 is used by users who utilize the information providing system 10. In particular, the terminal device 12 may be used by managers who manage a golf course. The terminal device 12 may be a mobile terminal device that can be mounted on a cart. The terminal device 12 may be a portable terminal device that can be carried by a worker.

The terminal device 12 obtains information from the information providing device 11 in response to a request for providing information in the information providing system 10. The terminal device 12 obtains information related to golf in the information providing system 10. The terminal device 12 may be a computer.

The terminal device 12 includes a terminal control unit 20, a terminal memory 21, a terminal communication unit 22, a terminal input unit 23, and a terminal display unit 24. The terminal control unit 20 is configured to control the terminal device 12. The terminal control unit 20 includes an arithmetic logic unit and a main storage medium. The arithmetic logic unit loads an operating system (OS) and programs from the terminal memory 21 into the main storage medium and executes instructions retrieved from the main storage medium. The arithmetic logic unit includes circuitry. The circuitry may include one or more processors, and the processors may include a central processing unit (CPU), a graphic processing unit (GPU), or a neural network processing unit (NPU).

The terminal memory 21 is a sub-storage medium, and is a storage that stores data related to users. The terminal memory 21 may store a program for sending and receiving data related to golf. The program may be a dedicated application for utilizing the information providing system 10.

The terminal communication unit 22 is implemented as hardware, software, or a combination thereof. The terminal communication unit 22 sends and receives data to and from the information providing device 11. The terminal input unit 23 is configured to input information in response to operation performed by a user. The terminal input unit 23 may be a touch screen integrated with the terminal display unit 24. The terminal input unit 23 may be a pointing device for an operation button. The terminal display unit 24 displays information in response to an output instruction from the terminal control unit 20.

The terminal device 12 includes a position measurement unit 25. The position measurement unit 25 obtains the position data of the terminal device 12 by measuring the position of the terminal device 12. The position measurement unit 25 may be a global positioning system (GPS) sensor.

### Configuration of Information Providing Device 11

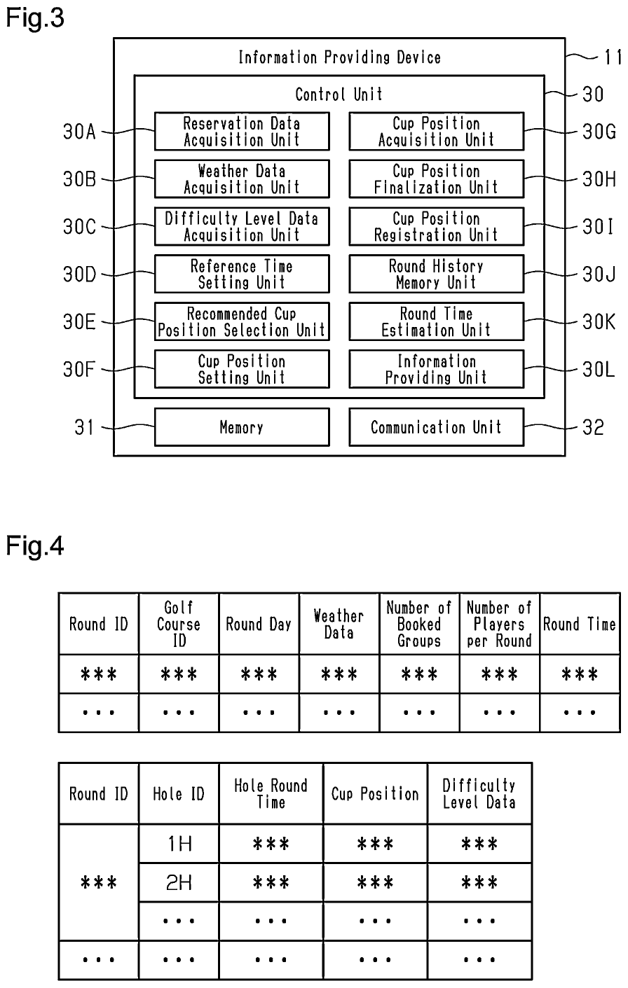

As shown in FIG. 3, the information providing device 11 is a server that provides information through communication with the terminal device 12. The information providing device 11 is a server that provides golf-related information to a golf course manager. In particular, the information providing device 11 provides the golf course manager with the estimated round time for a round day subsequent to tomorrow (i.e., a future day) that is estimated from the cup positions and weather data. The weather data includes a weather forecast for the round day that is used to predict the round time. The round time is the duration required to complete all holes for the round day. Round time typically refers to the play time excluding breaks, but it can also include break time.

The information providing device 11 includes a control unit 30, a memory 31, and a communication unit 32. The control unit 30 is configured to control the information providing device 11. The control unit 30 includes an arithmetic logic unit and a main storage medium. The arithmetic logic unit includes circuitry, and the circuitry includes one or more processors. The control unit 30 has the same configuration as the terminal control unit 20. Thus, the arithmetic logic unit and the main storage medium will not be described. The memory 31 is an auxiliary storage medium that stores data used to manage the information providing device 11.

The communication unit 32 is implemented as hardware, software, or a combination thereof. The communication unit 32 sends and receives data to and from the terminal device 12. The information providing device 11 may include an operation unit operated by an information provider who provides information, or may include a display unit that displays information.

By executing a program, the control unit 30 operates as a reservation data acquisition unit 30A, a weather data acquisition unit 30B, a difficulty level data acquisition unit 30C, and a reference time setting unit 30D. By executing another program, the control unit 30 operates as a recommended cup position selection unit 30E, a cup position setting unit 30F, a cup position acquisition unit 30G, a cup position finalization unit 30H, and a cup position registration unit 30I. By executing a further program, the control unit 30 operates as a round history memory unit 30J, a round time estimation unit 30K, and an information providing unit 30L.

The reservation data acquisition unit 30A obtains reservation data for the round day on the golf course. The reservation data acquisition unit 30A communicates with the first terminal device 12A to obtain reservation data for the round day on the golf course. Reservation data may include the number of booked groups corresponding to the round day. The number of booked groups indicates the number of user groups that have made a reservation for a round. In golf, it is common for a group of two to four players to play a round. Reservation data may include the number of players belonging to each group. Reservation data may include the start time for a round corresponding to each group.

The weather data acquisition unit 30B obtains weather data for the round day on the golf course. The weather data acquisition unit 30B communicates with a website (not shown) to obtain weather data for each round day on the golf course. Weather data may include weather information and wind speed information. Weather information may also include sunny, cloudy, rainy, and snowy conditions. Wind speed information may include wind speed and wind direction.

The difficulty level data acquisition unit 30C obtains difficulty level data that includes a difficulty level corresponding to each of cup positions (holes). For example, the difficulty level data acquisition unit 30C obtains the difficulty levels of all holes by communicating with the first terminal device 12A. The difficulty level may be indicated in multiple stages according to the degree of difficulty or in multiple degrees of gradation. The difficulty level may be set in advance for each of the holes. For example, the difficulty level may be categorized into three levels: low (easy), medium, and high (difficult). The difficulty level data may include a difficulty level set for each green of the holes. The difficulty level may be set within a certain area of the green. In this case, the area where the difficulty level is set is referred to as a difficult level area.

The reference time setting unit 30D sets a reference round time according to an operation by the golf course manager. The reference round time is a round time intended as a reference by the golf course manager. The reference round time is, for example, four hours and thirty minutes. The reference round time is information used to determine recommended cup positions.

The recommended cup position selection unit 30E may select a recommended cup position on each hole of the golf course for the round day, based on one or more selection conditions. The selection conditions may include at least one of the reservation data obtained by the reservation data acquisition unit 30A, the weather data obtained by the weather data acquisition unit 30B, the reference round time set by the reference time setting unit 30D, and the round history stored by the round history memory unit 30J. The recommended cup position selection unit 30E may set reference positions to one or more cup positions, of past cup positions registered by the cup position registration unit 30I, that were set during a specified period before the round day, and may set the recommended cup positions in an area that is located away from the reference positions by a predetermined distance or more.

According to the operation by the golf course manager, the cup position setting unit 30F sets, in the memory 31, the cup position for each hole on the golf course for the round day. Instead, the cup position setting unit 30F may be designed to change the recommended cup positions selected by the recommended cup position selection unit 30E according to the operation performed by the golf course manager.

The cup position acquisition unit 30G obtains the cup position for each hole on the golf course for the round day. In particular, the cup position acquisition unit 30G obtains the recommended cup positions selected by the recommended cup position selection unit 30E as the cup positions for the round day. The cup position acquisition unit 30G obtains, as the cup positions for the round day, the cup positions set by the cup position setting unit 30F.

The cup position finalization unit 30H finalizes the cup position at each hole on the golf course for the round day. In particular, the cup position finalization unit 30H finalizes, as the cup position for the round day, the cup position obtained by the cup position acquisition unit 30G. The cup position registration unit 30I registers the cup position finalized by the cup position finalization unit 30H in the memory 31 together with the corresponding round day. As a result, for each round day and for each of the holes, the past cup position history is stored in the memory 31.

The round history memory unit 30J stores the round history in the memory 31. As will be described in detail later, the round history refers to the records of rounds of each group on past round days. The round history memory unit 30J stores the obtained round history in the memory 31 through communication with the first terminal device 12A and a web server (not shown).

The round time estimation unit 30K may estimate the round time for each round day from one or more estimation conditions. The selection conditions may include at least one of the reservation data obtained by the reservation data acquisition unit 30A, the weather data obtained by the weather data acquisition unit 30B, the cup position obtained by the cup position acquisition unit 30G, the difficulty level of a cup position, and the round history.

The information providing unit 30L provides the golf course manager with the round time estimated by the round time estimation unit 30K. For example, the information providing unit 30L provides the golf course manager with the estimated round time estimated by the round time estimation unit 30K through communication with the first terminal device 12A.

### Round History

As shown in FIG. 4, the round history may include a round ID, golf course ID, round day, weather history including weather data, and reservation history including reservation data (e.g., the number of booked groups, number of players per round, and round time). The round ID is an identifier used to identify the round at each hole of a golf course. The round history may include a round start time, when the round begins at the first hole, and a round end time, when the round finishes at the last hole.

The round history includes information linked to hole IDs corresponding to a single round ID. The hole ID is an identifier used to identify each of the holes on a golf course. The round history includes a hole round time, cup positions, and difficulty level linked to each hole ID (i.e., for each hole). The hole round time is a round time in a corresponding round. The round history may include a hole round start time, when the round begins at the first hole, and a hole round end time, when the round finishes at the last hole. These times are linked to each hole ID. Thus, the round history may include, for each round day, a cup position history for each hole, reservation history, weather history, and round time history.

### Green Area

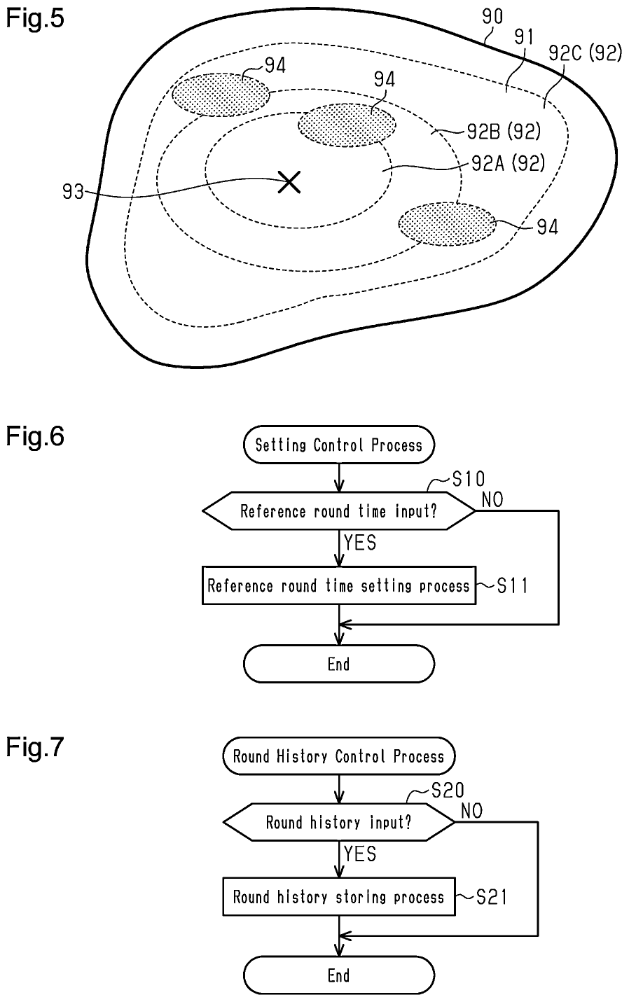

FIG. 5 illustrates a green area 90 that indicates the green in a certain hole. The green area 90 includes a cup allowable area 91. The cup allowable area 91 is an area where cup positions can be set. The cup allowable area 91 is an area that is located away from the edge of the green by a predetermined distance or more. In other words, cup positions are not set in an area that is within the predetermined distance from the edge of the green.

The green area 90 includes difficulty level areas 92. In other words, the difficulty level areas 92 are assigned to the green area 90 of each hole of the golf course. The difficulty level areas 92 are included within the cup allowable area 91.

The difficulty level areas 92 may include a first difficulty level area 92A, a second difficulty level area 92B, and a third difficulty level area 92C. The first difficulty level area 92A is an area with a lower difficulty level than the second difficulty level area 92B. The second difficulty level area 92B is an area with a lower difficulty level than the third difficulty level area 92C.

In the green area 90, a round-day cup position 93 can be set. The round-day cup position 93 is set on a specific round day. In FIG. 5, the round-day cup position 93 is set within the first difficulty level area 92A as the recommended cup position.

Cup restricted areas 94 are set within the green area 90. Each of the cup restricted areas 94 is an area where the setting of the round-day cup position 93 is restricted for the round day. Each of the cup restricted areas 94 is an area within a predetermined distance from one or more cup positions that were set within a specified period before the round day. The specified period may be the last three days, but it is not limited to this and may be, for example, the last seven days. The predetermined distance is four meters, but it is not limited to this and may be, for example, three or five meters.

### Setting Control Process

The setting control process will now be described with reference to FIG. 6. The setting control process is executed by the control unit 30 in the information providing device 11 at predetermined intervals.

As shown in FIG. 6, in step S10, the control unit 30 of the information providing device 11 determines whether the reference round time has been input through communication with the first terminal device 12A. The reference round time is sent from the first terminal device 12A to the information providing device 11 when the reference round time is set according to the operation by the golf course manager in the first terminal device 12A. The control unit 30 terminates the setting control process when it determines that no reference round time has been input. When determining that the reference round time has been input, the control unit 30 advances the process to step S11.

In step S11, the control unit 30 executes a reference round time setting process. In the reference round time setting process, the control unit 30 stores the input reference round time in the memory 31. Thus, the control unit 30 sets the reference round time based on the operation by the golf course manager. This enables the control unit 30 to specify the reference round time set in the first terminal device 12A. The memory 31 may store a default time that is set as the reference round time when the golf course manager does not designate a default time. When the reference round time setting process is completed, the control unit 30 terminates the setting control process.

### Round History Control Process

The round history control process will now be described with reference to FIG. 7. The round history control process is executed by the control unit 30 in the information providing device 11 at predetermined intervals.

As shown in FIG. 7, in step S20, the control unit 30 of the information providing device 11 determines whether a round history has been input through communication with the first terminal device 12A. When an input indicating that the round has ended is received by the first terminal device 12A, the round history is sent from the first terminal device 12A to the information providing device 11. In particular, when an input indicating that the user has holed out of each hole is received by the second terminal device 12B, the round time of the round history is sent from the second terminal device 12B to the first terminal device 12A. When the control unit 30 determines that no round history has been input, it terminates the round history control process. When determining that a round history input has been received, the control unit 30 advances the process to step S21.

In step S21, the control unit 30 executes a round history storing process. In the round history storing process, the control unit 30 stores the received round history in the memory 31. This enables the control unit 30 to specify the round history for each golf course.

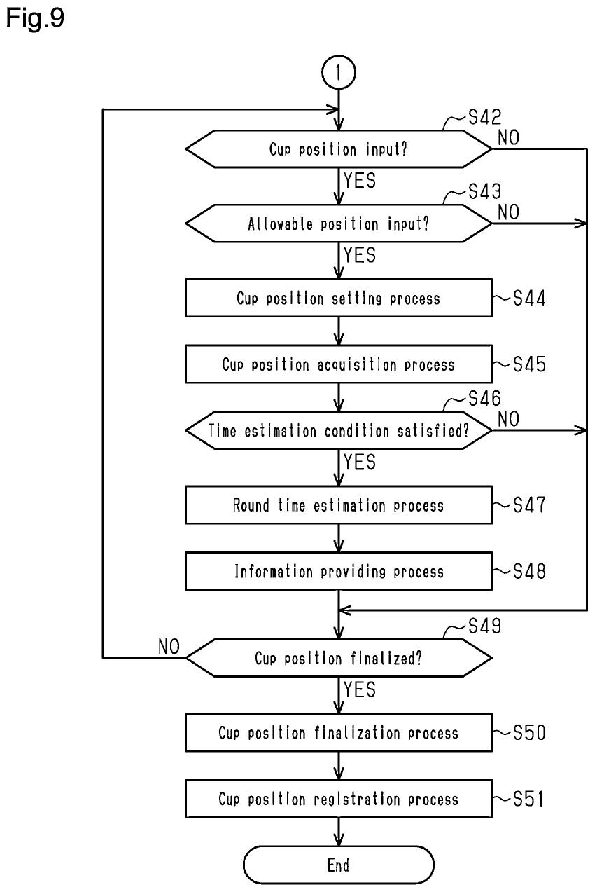

In particular, the control unit 30 stores a round history, including past reservation data, past weather data, past cup positions, and past round times in the memory 31. Specifically, the control unit 30 communicates with the first terminal device 12A to obtain past reservation data and past round times and store the obtained past reservation data and past round times in the memory 31 as the round history. The control unit 30 communicates with a web server (not shown) to obtain past weather data and store the obtained past weather data in the memory 31 as the round history. The control unit 30 reads the past cup positions registered in step S51 of FIG. 9, which will be described later, to store the past cup positions as the round history in the memory 31. When the round history storing process is completed, the control unit 30 terminates the round history control process.

### Cup Position Determination Process

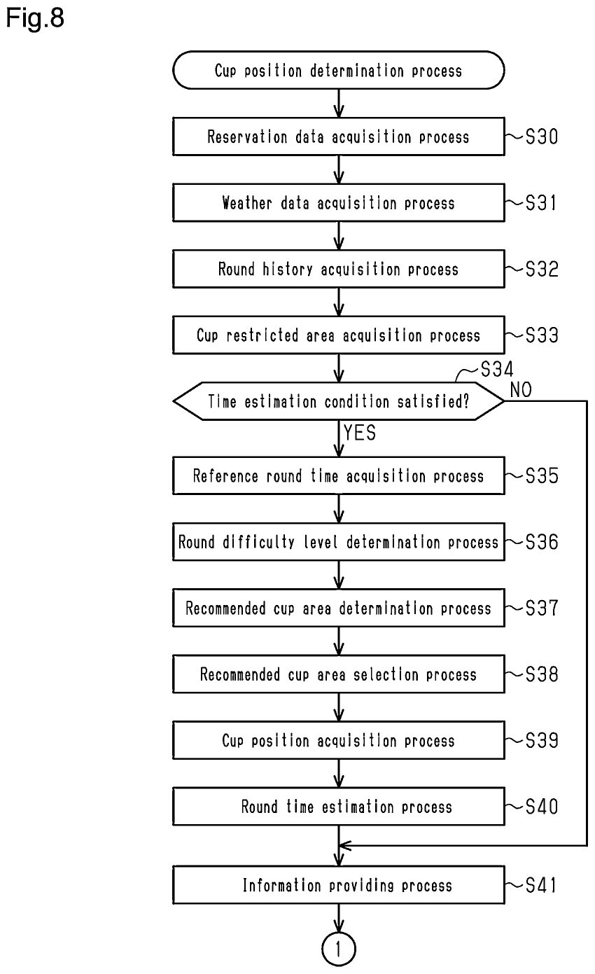

The cup position determination process will now be described with reference to FIGS. 8 and 9. The cup position determination process is executed by the control unit 30 when receiving a request to determine cup positions on a specific round day from the first terminal device 12A in the information providing device 11. Determination of the cup positions is requested according to the operation by the golf course manager in the first terminal device 12A. The cup position determination process is executed based on the data related to a golf course where the request for determining the cup positions has been made.

As shown in FIG. 8, in step S30, the control unit 30 of the information providing device 11 executes a reservation data acquisition process. In the reservation data acquisition process, the control unit 30 communicates with the first terminal device 12A to obtain the reservation data on the golf course for the round day. The reservation data is sent from the first terminal device 12A to the information providing device 11 at predetermined times.

In step S31, the control unit 30 executes a weather data acquisition process. In the weather data acquisition process, the control unit 30 obtains the weather data of the golf course for the round day. For example, the control unit 30 may obtain weather data of the golf course for the round day by communicating with a web server (not shown).

In step S32, the control unit 30 executes a round history acquisition process. In the round history acquisition process, the control unit 30 retrieves the round history by reading the round history stored in the memory 31. The retrieved round history includes, for example, past reservation data, past weather data, past cup positions, and past round times.

In step S33, the control unit 30 executes a cup restricted area acquisition process. In the cup restricted area acquisition process, the control unit 30 reads past cup positions, as the cup position history, from the round history stored in the memory 31. Specifically, the control unit 30 obtains one or more cup positions that were set within a specified period before the round day (e.g., the last specified period) as the cup position history. These cup positions are hereinafter referred to as cup positions during the specified period.

The control unit 30 obtains the cup restricted area 94 based on the cup position history. Specifically, the control unit 30 sets reference positions to the cup positions during the specified period to obtain, as the cup restricted area 94, an area within a predetermined distance from the reference positions.

In step S34, the control unit 30 determines whether a time estimation condition has been satisfied. The time estimation condition is satisfied when sufficient information is available to estimate the round time on the golf course. Specifically, the time estimation condition may be satisfied when the predetermined period has elapsed since the acquisition of the round history corresponding to the golf course began. When the control unit 30 determines that the time estimation condition is not satisfied, it advances the process to step S41. When the control unit 30 determines that the time estimation condition is satisfied, it advances the process to step S35.

In step S35, the control unit 30 executes a reference round time acquisition process. In the reference round time acquisition process, the control unit 30 obtains the reference round time by reading the reference round time stored in the memory 31.

In step S36, the control unit 30 executes a round difficulty level determination process. In the round difficulty level determination process, the control unit 30 determines the difficulty level of each hole based on at least one of the reservation data for the round day, weather data for the round day, reference round time, and round history.

For example, the control unit 30 refers to the round history to extract the round history corresponding to the reservation data for the round day, weather data for the round day, and reference round time. The control unit 30 may extract a round history in which the number of booked groups in the past and the number of booked groups on the round day are within a predetermined range. The control unit 30 may extract a round history in which the total number of players per round for all groups in the past and the total number of players per round for all groups on the round day are within a predetermined range. The control unit 30 may extract a round history that falls under the same predetermined category as the past weather data and the weather data for the round day. The categorization of weather conditions may be a combination of weather categorization and wind speed categorization. Weather may be classified into two conditions: clear or cloudy conditions and rainy or snowy conditions. Wind speed may be categorized into three ranges: less than two meters per second, from two meters to less than five meters per second, and five meters per second or more. The control unit 30 may extract a round history in which the past round time and the reference round time are within a predetermined range.

The control unit 30 obtains the cup position history for each hole included in the extracted round history. The control unit 30 may obtain the difficulty level data for each hole by calculating the average difficulty level corresponding to the obtained cup position history. For example, when a predetermined hole includes three instances of low difficulty (e.g., level 1) and one instance of medium difficulty (e.g., level 2) including past cup positions, the control unit 30 may calculate the average difficulty (e.g., the total difficulty levels of 5 divided by 4 equals 1.25) and obtain the difficulty level data for the round day as low difficulty level, rounding the average difficulty level of 1.25 to level 1. Thus, the control unit 30 obtains difficulty level data corresponding to the cup position of each hole on the golf course.

In step S37, the control unit 30 executes a recommended cup area determination process. In the recommended cup area determination process, the control unit 30 refers to the difficulty level of each hole on the golf course to determine the recommended cup area for the hole on the golf course.

For example, when the difficulty level at a predetermined hole on the golf course is low, the control unit 30 determines the first difficulty level area 92A as a first recommended cup area with the highest recommendation level. When the difficulty level at a predetermined hole on the golf course is low, the control unit 30 determines the second difficulty level area 92B as a second recommended cup area. The second recommended cup area has a lower recommendation level than the first recommended cup area. When the difficulty level at a predetermined hole on the golf course is low, the control unit 30 determines the third difficulty level area 92C as a third recommended cup area. The third recommended cup area has a lower recommendation level than the second recommended cup area.

In step S38, the control unit 30 executes a recommended cup position selection process. In the recommended cup position selection process, the control unit 30 selects the recommended cup position from within the first recommended cup area determined in step S37, excluding a restricted cup area. Thus, the control unit 30 selects the recommended cup position for each hole on the golf course for the round day based on the reservation data, weather data, and reference round time.

In step S39, the control unit 30 executes a cup position acquisition process. In the cup position acquisition process, the control unit 30 obtains the cup position selected in step S38 as the recommended cup position. In this manner, the control unit 30 obtains the cup position at each hole on the golf course for the round day. The control unit 30 refers to the cup position history to set the reference positions to the cup positions during the specified period and set the cup positions for the round day within a region that is located away from the reference positions by a predetermined distance or more.

In step S40, the control unit 30 executes a round time estimation process. In the round time estimation process, for example, the control unit 30 estimates the round time for the round day from the round history and from the reservation data, weather data, and recommended cup positions for the round day. In particular, the control unit 30 may estimate the round time for the round day from the difficulty level corresponding to the recommended cup position.

For example, the control unit 30 obtains the difficulty level corresponding to the recommended cup position for each hole for the round day. The control unit 30 refers to the round history to extract the round history corresponding to the reservation data for the round day, weather data, and difficulty level of the recommended cup position for the round day. The control unit 30 may extract a round history in which the number of booked groups in the past and the number of booked groups for the round day are within a predetermined range. For example, the control unit 30 may extract a round history in which the total number of players per round for all groups in the past and the total number of players per round for all groups on the round day fall within a predetermined range. The control unit 30 may extract a round history that falls under the same predetermined category as the past weather data and the weather data for the round day. The control unit 30 may extract a round history for each hole in which the past difficulty level data and the difficulty level of the recommended cup position for the round day are within a predetermined range.

The control unit 30 obtains the hole round time for each hole included in the extracted round history. The control unit 30 estimates the round time for the round day from the hole round time of each hole. Specifically, the control unit 30 calculates the average of the hole round times for holes and adds up the averages of the hole round times for all holes to estimate the round time for the round day.

In step S41, the control unit 30 executes an information providing process. In the information provision process, the control unit 30 sends information for the round day to the first terminal device 12A. Regardless of whether the time estimation condition is satisfied, the control unit 30 sends information indicating multiple cup restricted areas 94 for each hole on the golf course to the first terminal device 12A based on the cup position history. When determining that the time estimation condition is satisfied, the control unit 30 sends the obtained recommended cup position and the estimated round time to the first terminal device 12A. In the first terminal device 12A, the terminal control unit 20 causes the terminal display unit 24 to display the information sent from the information providing device 11. In this manner, the control unit 30 provides the obtained recommended cup position and the estimated round time.

As shown in FIG. 9, in step S42, the control unit 30 determines, through communication with the first terminal device 12A, whether the cup position has been input. When a cup position is designated in response to an operation by the golf course manager in the first terminal device 12A, the control unit 30 receives the cup position from the first terminal device 12A and determines that the cup position has been input. When determining that the cup position has not been input, the control unit 30 advances the process to step S49. When determining that the cup position has been input, the control unit 30 advances the process to step S43.

In step S43, the control unit 30 determines whether the input of the cup position is an input of a permitted position. The permitted position is a position within the cup allowable area 91 of each hole that is not the cup restricted area 94. When determining that the input of the cup position is not an input of the permitted position, the control unit 30 advances the process to step S49. In this case, the control unit 30 may send, to the first terminal device 12A, information indicating that the input of the cup position is invalid. When determining that the input of the cup position is an input of the permitted position, the control unit 30 advances the process to step S44.

In step S44, the control unit 30 executes a cup position setting process. In the cup position setting process, the control unit 30 sets the cup position by storing, in the memory 31, the cup position that has been input through communication with the first terminal device 12A. Thus, according to the operation by the golf course manager, the control unit 30 sets, in the memory 31, the cup position for each hole on the golf course for the round day.

In step S45, the control unit 30 executes a cup position acquisition process. In the cup position acquisition process, the control unit 30 obtains the cup position set in step S44. In this manner, the control unit 30 obtains the cup position at each hole on the golf course for the round day. Referring to the cup position history, the reference positions are set to the cup positions during the specified period and the cup positions for the round day are set within the area that is located away from the reference positions by the predetermined distance or more.

In step S46, the control unit 30 determines whether the time estimation condition is satisfied, in the same manner as step S34. When determining that the time estimation condition is not satisfied, the control unit 30 advances the process to step S49. When determining that the time estimation condition is satisfied, the control unit 30 advances the process to step S47.

In step S47, the control unit 30 executes the round time estimation process based on the cup position obtained in step S45, in the same manner as step S40. In the round time estimation process, the control unit 30 estimates the round time for the round day from the round history and from the reservation data, weather data, and cup position for the round day. Specifically, the control unit 30, unlike in step S40, estimates the round time for the round day from the difficulty level of the cup position set in step S44, instead of that of the recommended cup position.

In step S48, the control unit 30 executes an information providing process in the same manner as step S41. In the information providing process, the control unit 30 sends the obtained cup position and the estimated round time to the first terminal device 12A. In the first terminal device 12A, the terminal control unit 20 causes the terminal display unit 24 to display the information sent from the information providing device 11. In this manner, the control unit 30 provides the obtained cup position and the estimated round time.

In step S49, the control unit 30 determines, through communication with the first terminal device 12A, whether the cup position has been finalized. When an input indicating the golf course manager performs an operation to finalize the cup position is received by the first terminal device 12A, the control unit 30 determines that the cup position has been finalized. When determining that the cup position has not been finalized, the control unit 30 advances the process to step S42 again. When determining that the cup position has been finalized, the control unit 30 advances the process to step S50.

In step S50, the control unit 30 executes a cup position finalization process. In the cup position finalization process, the control unit 30 specifies the cup position obtained in step S39 and step S45 as the finalized cup position. Thus, the control unit 30 finalizes the cup position at each hole on the golf course for the round day.

Int step S51, the control unit 30 executes a cup position registration process. In the cup position registration process, the control unit 30 registers the cup position determined in step S50 in the memory 31 in correspondence with the round day. Thus, the control unit 30 registers the finalized cup position as the cup position history in the memory 31. When the cup position registration process is completed, the control unit 30 terminates the cup position determination process.

### Operation of Embodiment

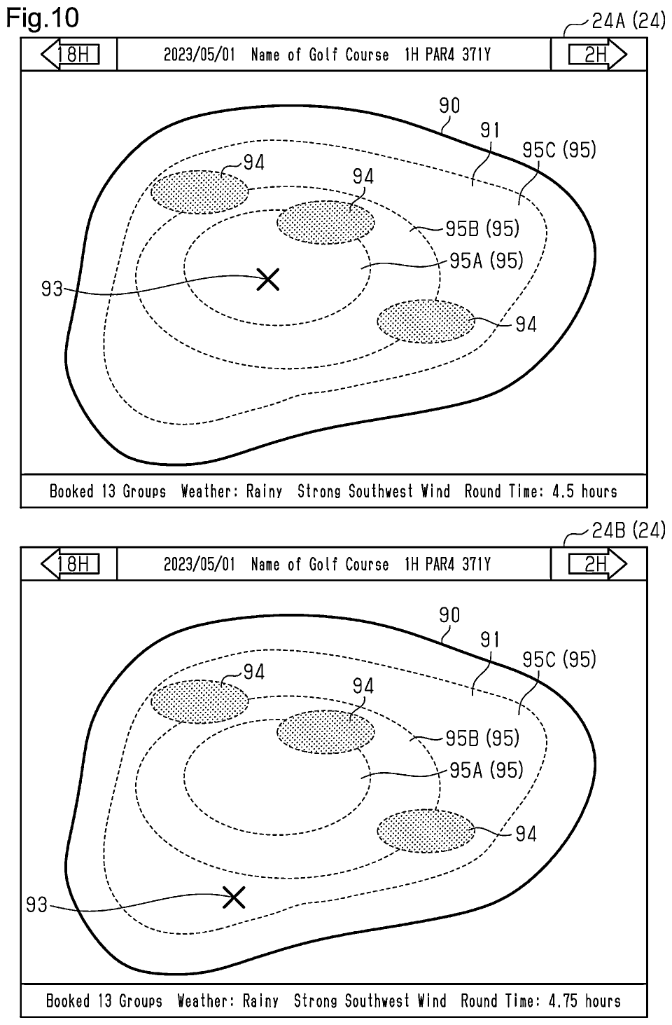

As shown in FIG. 10, the terminal display unit 24 of the first terminal device 12A displays a first screen 24A. The first screen 24A displays the recommended cup position for the round day.

The first screen 24A displays the green area 90 on a predetermined hole of the golf course. The first screen 24A displays the cup allowable area 91. The cup allowable area 91 is displayed within the green area 90.

The first screen 24A displays multiple recommended cup areas 95. The recommended cup areas 95 are displayed within the cup allowable area 91. The recommended cup areas 95 may include a first recommended cup area 95A, a second recommended cup area 95B, and a third recommended cup area 95C. In this case, the first recommended cup area 95A corresponds to an area with a lower difficulty level than the second recommended cup area 95B. The second recommended cup area 95B corresponds to an area with a lower difficulty level than the third recommended cup area 95C.

The first screen 24A displays the round-day cup position 93. In this case, the round-day cup position 93 indicates the recommended cup position. The round-day cup position 93 is displayed within the first recommended cup area 95A. The first screen 24A displays multiple cup restricted areas 94. The cup restricted areas 94 are displayed within the green area 90.

The first screen 24A displays the number of booked groups for the round day as reservation data. The first screen 24A displays the weather data for the round day. The first screen 24A displays the round time estimated for the round day.

In the first terminal device 12A, the cup position may be modified in response to an operation by the golf course manager. In such a case, the terminal display unit 24 may display a second screen 24B.

The second screen 24B displays a modified round-day cup position 93. In this case, the round-day cup position 93 is displayed within the second recommended cup area 95B. The second screen 24B displays the round time corresponding to the modified round day and cup position 93. In this case, since the cup position 93 for the round day has been modified from the first recommended cup area 95A to the second recommended cup area 95B, which has a higher difficulty level than the first recommended cup area 95A, the round time is longer.

### Advantages of Embodiment

(1) The control unit 30 estimates the round time for the round day from the weather data for the round day on the golf course and the cup position at each hole on the golf course for the round day. The control unit 30 provides the estimated round time. This configuration provides round times that take into account the weather data and cup positions on the golf course for the round day. Thus, the accuracy of round time estimation is improved. Accordingly, the user is provided with an estimated round time that is highly accurate.

(2) The control unit 30 estimates the round time for the round day from the reservation data on the golf course for the round day. This configuration provides round times that take into account the weather data, reservation data, and cup positions on the golf course for the round day. Thus, the accuracy of round time estimation is improved.

(3) The control unit 30 registers the finalized cup position in correspondence with the round day. Based on the previously registered cup positions, the control unit 30 sets the cup positions for the round day within an area that is located away from the positions, by a predetermined distance or more, where cups were set during the specified period. In this configuration, cup positions are set at positions that are located away from the cup positions, by the predetermined distance or more, that were set within the specified period before the round day. This avoids situations in which the cup position is set at the same position every day and the grass on the green is damaged.

(4) The control unit 30 selects the recommended cup position based on weather data and obtains the selected recommended cup position. This configuration recommends a cup position on a golf course that takes into account the weather data for the round day.

(5) The control unit 30 selects the recommended cup position based on the reference round time set according to an operation by the golf course manager. This configuration recommends a cup position that takes into account the weather data and reference round time.

(6) The control unit 30 sets, in the memory 31, the cup position for each hole on the golf course for the round day according to an operation by the golf course manager. This configuration allows the golf course manager to set the cup position as intended and provide the round time for the round day based on the set cup position.

(7) The control unit 30 stores a round history, including past reservation data, past weather data, past cup positions, and past round times. The control unit 30 estimates the round time for the round day from the round history, reservation data, weather data, and cup positions. This configuration estimates the round time for the round day by taking into account an actual round history. Thus, the accuracy of round time estimation is improved.

(8) The control unit 30 estimates the round time for the round day from the difficulty level of each cup position. This configuration estimates the round time by taking into account the difficulty level of each cup position. Thus, the accuracy of round time estimation is improved.

### Modifications

The present embodiments may be modified as follows. The present embodiment and the following modifications can be combined as long as they remain technically consistent with each other.

Weather data may include at least one of temperature and humidity in addition to weather information and wind speed information. Weather data does not have to include either weather information or wind speed information.

The difficulty level may be set in advance according to weather. For example, the difficulty level may be set to low when the weather is clear or cloudy, and to high when the weather is rainy or snowy. Alternatively, the difficulty level may be set to low when the wind speed is less than two meters per second, medium when the wind speed is greater than or equal to two and less than five meters per second, and high when the wind speed is greater than or equal to five meters per second.

The difficulty level may be set in advance based on the inclination of the green. Instead, the difficulty level may be set in advance based on the grain of the green. Alternatively, the difficulty level may be set in advance based on whether a penalty area is located around the green.

The control unit 30 may estimate the difficulty level from the round history. For example, the control unit 30 may estimate the difficulty level by setting the difficulty level area 92 on the green area 90 from the past hole round times included in the round history. In this case, the control unit 30 may adopt the past reservation data and past weather data included in the round history as conditions for setting the difficulty level.

To strike a balance between the difficulty levels on the entire course, the control unit 30 may adjust the number of holes at each difficulty level after setting the default value for the number of holes at the difficulty level. For example, of all eighteen holes, the control unit 30 sets six high-level holes, six low-level holes, and six medium-level holes as the default number of holes. Alternatively, the control unit 30 may set the standard condition to a condition in which the weather is sunny or cloudy and the wind speed is less than two meters. When the weather is rainy or snowy and the wind speed is less than two meters, the control unit 30 may increase the number of low-level holes by one and decrease the number of high-level holes by one from the default number of holes. As another option, when the weather is sunny or cloudy and the wind speed is greater than or equal to two meters and less than five meters, the control unit 30 may increase the number of low-level holes by one and decrease the number of high-level holes by one from the default number of holes.

The control unit 30 may determine the difficulty level such that consecutive holes of all the holes have the same difficulty level or each of them has a different difficulty level. For example, the control unit 30 may perform control such that the difficulty level varies in consecutive holes.

The control unit 30 may determine the difficulty level based on the designated number of strokes to achieve par on each hole. For example, the control unit 30 may determine the difficulty level such that a hole with a large designated number of strokes has a lower level than a hole with a small designated number of strokes. Alternatively, the control unit 30 may determine the difficulty level such that a hole with a small designated number of strokes has a lower level than a hole with a large designated number of strokes.

The control unit 30 may determine, for each hole, the difficulty level based on the designated number of strokes to achieve par in the subsequent hole. For example, the control unit 30 may determine the difficulty level such that the difficulty level is high when the designated number of strokes in the subsequent hole is small. In holes where the designated number of strokes is low, the tee shot ball is likely to directly reach the green. This increases the likelihood that the next group of golfers will have to wait to take their tee shot while play is ongoing on the green. Thus, the waiting time is reduced by increasing the difficulty level of the hole immediately preceding a hole with a small designated number of strokes.

The time estimation condition may be satisfied when the number of round histories corresponding to the golf course is greater than a predetermined number of times. Instead, the time estimation condition may be satisfied when the number of round histories to be extracted is greater than a predetermined number of times.

The control unit 30 may determine the recommended cup area and recommended cup positions based on a predetermined reference round time, instead of the reference round time set according to the operation by the golf course manager. In this case, the control unit 30 does not have to allow the reference round time to be changed according to the operation by the golf course manager.

Without obtaining actual reservation data, the control unit 30 may determine the recommended cup area and recommended cup positions based on the maximum number of groups on a predetermined round day and estimate the round time. For example, even if the number of actual booked groups is ten and the maximum number of groups is determined as thirteen in advance, the control unit 30 may determine the recommended cup area and recommended cup positions and estimate the round time based on the assumption that the number of booked groups is thirteen.

If the round day used to estimate the round time is more than two days ahead, the specified period closest to that round day may include one or more future days. In this case, the cup position history may include the estimated future cup positions (scheduled cup positions) in addition to or instead of past cup positions. The weather data may include future data such as weather forecasts, scheduled cup positions, and expected round times.

In the first terminal device 12A, the terminal control unit 20 may obtain past round times in response to the operation by the golf course manager and send them to the information providing device 11. The control unit 30 may obtain the past round times by communicating with a terminal device that is carried by the user. In such a case, in the terminal device carried by the user, the terminal control unit 20 may send the end time of each completed hole to the information providing device 11.

In the first terminal device 12A, the terminal control unit 20 may send the finalized cup position for each hole to the third terminal device 12C. Thus, the finalized cup position for each hole is provided to a worker who will actually install the cups. This improves the operational efficiency of installing cups at the cup positions of each hole.

The first terminal device 12A may include some of the functions of the information providing device 11. In other words, the information providing system 10 may distribute the functions of the information providing device 11 between the information providing device 11 and the first terminal device 12A.

### CLAUSES

The technical ideas understood from the embodiments and modifications and their operational advantages will now be described below.

### Clause 1

An information providing device, including:
a weather information acquisition unit that obtains weather information for a round day on a golf course;
a cup position acquisition unit that obtains a cup position for each of holes on the golf course for the round day;
a round time estimation unit that estimates a round time for the round day from the weather information obtained by the weather information acquisition unit and the cup position obtained by the cup position acquisition unit; and
an information providing unit that provides the round time estimated by the round time estimation unit.

### Clause 2

The information providing device, including a reservation information acquisition unit that obtains reservation information for the round day on the golf course, where
the round time estimation unit estimates the round time for the round day from the reservation information obtained by the reservation information acquisition unit.

### Clause 3

The information providing device, including:
a cup position finalization unit that finalizes a cup position for each of the holes on the golf course for the round day; and
a cup position registration unit that registers the cup position finalized by the cup position registration unit in correspondence with the round day, where
   the cup position acquisition unit obtains the cup position for each of the holes on the golf course for the round day based on a result registered by the cup position registration unit, from an area that is located away from a cup position corresponding to a specified day before the round day by a predetermined distance or more.

### Clause 4

The information providing device, including a recommended cup position selection unit that selects a recommended cup position for each of the holes of the golf course for the round day, where
the recommended cup position selection unit selects a recommended cup position for each of the holes of the golf course for the round day, based on the weather information obtained by the weather information acquisition unit, and
the cup position acquisition unit obtains the recommended cup position selected by the recommended cup position selection unit.

### Clause 5

The information providing device, including a reference time setting unit that sets a reference round time according to an operation by a manager of the golf course, where
the recommended cup position selection unit selects a recommended cup position for each of the holes of the golf course for the round day, based on the weather information obtained by the weather information acquisition unit and the reference round time set by the reference time setting unit.

### Clause 6

The information providing device, including a cup position setting unit that sets, in a memory, the cup position for each of the holes of the golf course for the round day according to an operation by a manager of the golf course, where
the cup position acquisition unit obtains the cup position selected by the cup position setting unit.

### Clause 7

The information providing device, including:
a reservation information acquisition unit that obtains reservation information for the round day on the golf course; and
a round history memory unit that stores a round history that includes past reservation information, past weather information, past cup positions, and past round times, where
the round time estimation unit estimates a round time for the round day from the round history stored in the round history memory unit, the reservation information obtained by the reservation information acquisition unit, the weather information obtained by the weather information acquisition unit, and the cup position obtained by the cup position acquisition unit.

### Clause 8

The information providing device, including a difficulty level information acquisition unit that obtains difficulty level information corresponding to the cup position for each of the holes on the golf course, where
the round time estimation unit that estimates a round time for the round day from the weather information obtained by the weather information acquisition unit and the difficulty level information that corresponds to the cup position obtained by the cup position acquisition unit and that has been obtained by the difficulty level information acquisition unit.

### Clause 9

An information providing system, including:
a weather information acquisition unit that obtains weather information for a round day on a golf course;
a cup position acquisition unit that obtains a cup position for each of holes on the golf course for the round day;
a round time estimation unit that estimates a round time for the round day from the weather information obtained by the weather information acquisition unit and the cup position obtained by the cup position acquisition unit; and
an information providing unit that provides the round time estimated by the round time estimation unit.

### Clause 10

An information providing method, including:
obtaining, by one or more computers, weather information for a round day on a golf course;
obtaining, by the one or more computers, a cup position for each of holes on a golf course for the round day;
estimating, by the one or more computers, a round time for the round day based on the obtained weather information and the obtained cup positions; and
providing, by the one or more computers, the estimated round time.

### Clause 11

A program that causes one or more computers to execute:
obtaining weather information for a round day on a golf course;
obtaining a cup position for each of holes on a golf course on the round day;
estimating a round time for the round day based on the obtained weather information and the obtained cup positions; and
providing the estimated round time.

The expression “at least one of” as used herein means “one or multiple” of desired options. For example, the phrase “at least one of” as used in this description means “only one choice” or “both of two choices” in a case in which the number of choices is two. In another example, the phrase “at least one of” as used in this description means “only one single choice” or “any combination of two or more choices” if the number of its choices is three or more.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Appropriate results can be achieved if the sequences are executed in a different order, and/or the configurations within the described system, structure, device, or circuit are combined in a different manner, and/or replaced or supplemented by other components or their equivalents.

What is claimed is:

1. An information providing system, comprising:
one or more processors; and
a memory that stores one or more programs executed by the one or more processors, wherein
the one or more programs cause the one or more processors to execute:
obtaining weather data for one round day on a golf course, the golf course including holes;
obtaining cup positions set respectively in the holes for the one round day;
estimating a round time for the one round day from the weather data and the cup positions; and
providing the estimated round time.

2. The information providing system according to claim 1, wherein
the one or more programs cause the one or more processors to further execute obtaining reservation data for the one round day on the golf course, and
the estimating the round time includes estimating the round time for the one round day from the reservation data for the one round day.

3. The information providing system according to claim 1, wherein
the one or more programs cause the one or more processors to execute:
finalizing, for each of round days, multiple cup positions on a corresponding one of the round days;
registering the finalized multiple cup positions together with the corresponding round day;
storing a cup position history in the memory based on the finalizing and the registering; and
for each of the cup positions for the one round day, referring to the cup position history to set reference positions to one or more cup positions that were set during a specified period before the one round day and set cup positions for the one round day in an area that is located away from the reference positions by a predetermined distance or more.

4. The information providing system according to claim 1, wherein
the one or more programs cause the one or more processors to further execute selecting recommended cup positions for the holes, respectively, based on the weather data, and
the obtaining the cup positions includes obtaining the recommended cup positions.

5. The information providing system according to claim 4, wherein
the one or more programs cause the one or more processors to execute setting a reference round time according to an operation by a manager of the golf course, and
the selecting the recommended cup positions includes selecting the recommended cup positions for the one round day based on the weather data and the reference round time.

6. The information providing system according to claim 1, wherein
the one or more programs cause the one or more processors to further execute storing the cup positions for the one round day in the memory in response to an operation by a manager of the golf course, and
the obtaining the cup positions includes obtaining the recommended cup positions stored in the memory.

7. The information providing system according to claim 1, wherein
the memory stores a round history for the golf course, the round history including a reservation history, a weather history, a cup position history, and a round time history for each of past round days,
the one or more programs cause the one or more processors to further execute obtaining reservation data for the one round day on the golf course, and
the estimating the round time includes estimating the round time for the one round day from the cup positions for the one round day, the round history, the reservation data, and the weather data.

8. The information providing system according to claim 1, wherein
the one or more programs cause the one or more processors to further execute obtaining difficulty level data that includes difficulty levels set respectively for the cup positions, and
the estimating the round time includes estimating the round time for the one round day from the weather data and the difficulty level data.

9. An information providing method, comprising:
obtaining, by one or more computers, weather data for one round day on a golf course, the golf course including holes;
obtaining, by the one or more computers, cup positions set respectively in the holes for the one round day;
estimating, by the one or more computers, a round time for the one round day from the weather data and the cup positions; and
providing, by the one or more computers, the estimated round time.

10. A non-transitory computer-readable medium storing a program for causing one or more computers to execute:
obtaining weather data for one round day on a golf course, the golf course including holes;
obtaining cup positions set respectively in the holes for the one round day;
estimating a round time for the one round day from the weather data and the cup positions; and
providing the estimated round time.
